(19) United States
(12) Patent Application Publication
(10) Pub. No.: US 2005/0263251 A1
(43) Pub. Date: Dec. 1, 2005

(54) Board picking up apparatus and method for use therewith

(75) Inventor: Yuji Mizuno, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/118,395

(22) Filed: May 2, 2005

(30) Foreign Application Priority Data
May 25, 2004 (JP) 2004-154495

(51) Int. Cl. B32B 31/24

(52) U.S. Cl. 156/379.6; 156/273.1; 156/344

(57) ABSTRACT

A board picking up apparatus of the present invention protrudes an adhesive member arm 73 into a board case 71 with an adhesive member 74 facing downward (step S51), and brings an upper surface of a board S placed on the top of the loaded boards S into contact with the adhesive member 74 (step S52). Then, a lifting table 72 moves downward (step S53), thereby protruding the other end of an interposing member 76 into the board case 71 (step S54). Thus, the other end of the interposing member 76 is inserted into a gap between the top board S and the other boards S, and the top board S is suctioned by an A-side inspecting suction table 22 (step S58).

### BACKGROUND OF THE INVENTION

1. Field of the Invention

The present invention relates to a board picking up apparatus and a method for use therewith, more particularly, relates to a board picking up apparatus for picking up boards loaded therein one at a time, and a method for use therewith.

2. Related Art Statement

Conventionally, an apparatus for supplying sheet-shaped members loaded therein one at a time, top member first, has to prevent two or more members from being supplied at one time. As a method to separate a top member from the remaining members, utilization of a tab for preventing two members from being supplied at one time is known. Also, some methods may spray air for separation purposes from the side of the loaded members, or shake the remaining members off the top member by creating vibration, for example (a “shaking-off” operation).

Also, Japanese Laid-Open Patent Publication No. 11-208913 discloses a sheet separating apparatus for separating a top sheet from the second sheet by inserting a tab member therebetween.

As shown in FIG. 21, assume that the above-described sheet-shaped member is a board S such as a printed board for implementing an electronic part (e.g., a semiconductor device) thereon. The board S has a plurality of perforations penetrating therethrough, such as through-holes TH (corresponding to the filled circles in the drawing) and slits SL (corresponding to the portions hatched with oblique line in the drawing). Such aboard S is loaded in the board supplying section. In the case where a top board S is picked up from the board supplying section by means of total vacuum suction, the boards S lying under the top board may also have strong suction force.

As shown in FIG. 22, a blower suction method by which a board S loaded in a board case 502 is vacuum-suctioned to a suction surface of a suction table 501 will be described. FIGS. 22A and 22B are schematic cross-sectional views each showing a structure of a blower vacuum apparatus. A plurality of suction holes are formed on the suction surface of the suction table 501. The plurality of suction holes are suctioned by a blower (not shown). In the case where the suction surface of the suction table 501 is disposed in the neighborhood of an opening of the board case 502, negative pressure is created inside the board case 502. As a result, the top board S is vacuum-suctioned to the suction surface due to suction force of the suction table 501, and picked up from the board case 502.

However, as shown in FIG. 22A, due to a plurality of perforations penetrating through the board S (i.e., through-holes TH and slits SL), suction force of the suction table 501 also acts on the boards S lying under the top board. For instance, assume that the top and second boards S are in close contact with each other, and the third board S suffers warping. In this case, suction force strongly acts on the second board S. The reason for this is as follows: negative pressure exists in a gap between the top board S and the suction table 501 by the blower suction, whereas positive pressure (atmospheric pressure) exists in a gap between the second and third boards S. Due to such negative and positive pressures, the top and second boards S tend to move upward. Similarly, in the case where the edges of the top board S and the second board S are misaligned, the second board S tends to move upward since the through-holes TH and the slits SL formed in the top board S act in a manner similar to the suction holes of the suction table 501. Thus, as shown in FIG. 22B, the top and second boards S are picked up at the same time, and vacuum-suctioned to the suction surface of the suction table 501. Two boards picked up in the manner as described above cannot be separated from each other by the above-described prevention tab utilizing method or separation air utilizing method. In addition, reliable separation of two boards by the prevention tab requires the prevention tab to hit the board S. Thus, the board S may be damaged.

The sheet separating apparatus as disclosed in Japanese Laid-Open Patent Publication No. 11-208913 also employs a method for picking up a board S by partial vacuum suction thereof with the use of a suction pad having a small suction area. However, in this method, a portion having no through-holes TH or slits SL needs to be in contact with the suction pad, whereby it is necessary to adjust a position of the suction pad according to a shape of the board S to be supplied. Such an adjustment has to be performed for each board. In addition, intensive stress is exerted on the board S due to partial vacuum suction of the board S, which may result in deformation or defacement of the board S. Furthermore, shapes of some boards S do not allow the suction pad to be attached thereto due to the absence of an appropriate portion having no perforations, whereby picking up thereof is impossible. Also, it is difficult to apply the sheet separating apparatus as disclosed in Japanese Laid-Open Patent Publication No. 11-208913 to a board S such as a printed board due to bending stress exerted on a sheet.

### SUMMARY OF THE INVENTION

Therefore, an object of the present invention is to provide a board picking up apparatus and a method for use therewith for picking up only a top board loaded therein without damaging the board while preventing two boards from being picked up at the same time.

The present invention has the following features to attain the object mentioned above.

A first aspect of the present invention is directed to a board picking up apparatus for picking up a board from loaded boards. The board picking up apparatus comprises: a board case; an adhesive member; an adhesive member supporting section; an adhesive member moving section; an interposing member; an interposing member moving section; and a suction table. The board case accommodates the loaded boards. The adhesive member adheres to the board accommodated in the board case. The adhesive member supporting section supports the adhesive member. The adhesive member moving section moves the adhesive member supporting section between a position in which the adhesive member protrudes into the board case and a position in which the adhesive member retracts away therefrom. The interposing member moving section moves the interposing member between a position in which the interposing member protrudes into the board case and a position in which the interposing member retracts away therefrom. The suction table vacuum-suctions the board to a suction surface thereof by suctioning the board through an upper portion of the board case. The adhesive member moving section moves the adhesive member of the adhesive member supporting section so as to protrude into the board case, and causes a loaded top board to adhere to the adhesive member. The interposing member moving section inserts the interposing member into a gap formed between the board adhering to the adhesive member and other boards by moving the interposing member to protrude into the board case. The adhesive member moving section releases the top board adhering to the adhesive member from the adhesive member with the interposing member being inserted in the gap, and moves the adhesive member supporting member to the position where the adhesive member is retracted away from the board case. The suction table vacuum-suctions the top board with the interposing member being inserted in the gap.

According to a second aspect, in the first aspect, the gap is formed, after the top board adheres to the adhesive member, by increasing a relative difference in level between the top board adhering to the adhesive member and the other boards.

According to a third aspect, in the first aspect, the board picking up apparatus further comprises a lifting table for moving up and down the loaded boards in the board case. The lifting table causes the loaded top board to adhere to the adhesive member when the adhesive member moving section moves up with the adhesive member of the adhesive member supporting section being protruded into the board case. The lifting table forms a gap between the top board and the other boards when the top board adhering to the adhesive member moves downward.

According to a fourth aspect, in the first aspect, the adhesive member moving section further rotates the adhesive member supporting section in a predetermined rotational direction. The adhesive member supporting section supports the adhesive member such that a portion thereof faces downward with respect to the rotational direction. For example, the adhesive member supporting section is cut so as to have a D shape in cross section (D-cut), and the adhesive member is attached to the D-cut portion. The adhesive member moving section releases the top board adhering to the adhesive member from the adhesive member by rotating the adhesive member supporting section in the rotational direction with the interposing member being inserted in the gap.

According to a fifth aspect, in the first aspect, the board picking up apparatus further comprises adhesive power recovery means. The adhesive power recovery means cleanses an adhesive surface of the adhesive member by coming in contact with the adhesive surface of the adhesive member, to which a board adheres, at a predetermined time.

According to a sixth aspect, in the first aspect, the adhesive member is a tape-shaped member whose one principal surface is adhesive. The adhesive member supporting section further includes adhesive member replacing means. The adhesive member replacing means replaces a portion of an adhesive surface of the adhesive member, to which a board adheres, with any other portion of the adhesive member at a predetermined time.

A seventh aspect of the present invention is directed to a board picking up apparatus for picking up a board from loaded boards. The board picking up apparatus comprises: a board case; an electrostatic suction member; an electrostatic suction member moving section; an interposing member; an interposing member moving section; and a suction table. The board case accommodates the loaded boards. The electrostatic suction member electrostatic-suctions the board accommodated in the board case. The electrostatic suction member moving section moves the electrostatic suction member between a position in which the electrostatic suction member protrudes into the board case and a position in which the electrostatic suction member retracts away therefrom. The interposing member moving section moves the interposing member between a position in which the interposing member protrudes into the board case and a position in which the interposing member retracts away therefrom. The suction table vacuum-suctions the board to a suction surface thereof by suctioning the board through an upper portion of the board case. The electrostatic suction member moving section moves the electrostatic suction member so as to protrude into the board case, and causes the electrostatic suction member to electrostatic-suction a loaded top board. The interposing member moving section inserts the interposing member into a gap formed between the board suctioned by the electrostatic suction member and the other boards by moving the interposing member so as to protrude into the board case. The electrostatic suction member moving section moves the electrostatic suction member so as to retract away from the board case by releasing the top board suctioned by the electrostatic suction member from the electrostatic suction member with the interposing member being inserted in the gap. The suction table vacuum-suctions the top board with the interposing member being inserted in the gap.

An eighth aspect of the present invention is directed to a board picking up method for picking up a board from loaded boards. The board picking up method comprises: a board adhering step; an interposing member inserting step; a board adhesion releasing step; and a vacuum suctioning step. The board adhering step causes a loaded top board to adhere to an adhesive member by placing the adhesive member over the loaded boards. The interposing member inserting step inserts an interposing member into a gap formed between the board adhering to the adhesive member and other boards by moving the interposing member in a space where the boards are loaded. The board adhesion releasing step retracts the adhesive member away from a position over the loaded boards by releasing the top board adhering to the adhesive member from the adhesive member with the interposing member being inserted in the gap. The vacuum suctioning step vacuum-suctions the top board to a suction surface of a suction table by suctioning the board from above with the interposing member being inserted in the gap.

According to a ninth aspect, in the eighth aspect, the board picking up method further comprises a gap forming step. The gap forming step forms the gap, after causing the top board to adhere to the adhesive member at the board adhering step, by increasing a relative difference in level between the top board adhering to the adhesive member and the other boards.

According to a tenth aspect, in the ninth aspect, the board adhering step causes the loaded top board to adhere to the adhesive member by placing the adhesive member over the loaded boards, and moving up the loaded boards. After the top board adheres to the adhesive member at the board adhering step, the gap forming step forms the gap by moving down the loaded boards.

According to an eleventh aspect, in the eighth aspect, the adhesive member is structured such that a portion thereof faces downward with respect to a predetermined rotational direction. The board adhesion releasing step releases the top board adhering to the adhesive member from the adhesive member by rotating the adhesive member in the rotational direction with the interposing member being inserted in the gap.

According to a twelfth aspect, in the eighth aspect, the board picking up method further comprises an adhesive power recovering step. The adhesive power recovering step cleanses an adhesive surface of the adhesive member by bringing the adhesive surface of the adhesive member, to which a board adheres, into contact with a predetermined member at a predetermined time.

According to a thirteenth aspect, in the eighth aspect, the board picking up method further comprises an adhesive member replacing step. The adhesive member is a tape-shaped member whose one principal surface is adhesive. The adhesive member replacing step replaces a portion of an adhesive surface of the adhesive member, to which a board adheres, with any other portion of the adhesive member at a predetermined time.

A fourteenth aspect of the present invention is directed to a board picking up method for picking up a board from loaded boards. The board picking up method comprises: a board electrostatic suctioning step; an interposing member inserting step; a board electrostatic suction releasing step; and a vacuum suctioning step. The board electrostatic suctioning step places an electrostatic suction member over the loaded boards, and causes the electrostatic suction member to electrostatic-suction a loaded top board. The interposing member inserting step inserts an interposing member in a gap formed between the board suctioned by the electrostatic suction member and other boards by moving the interposing member in a space where the boards are loaded. The board electrostatic suction releasing step retracts the electrostatic suction member away from a position over the loaded boards by releasing the top board suctioned by the electrostatic suction member from the electrostatic suction member with the interposing member being inserted in the gap. The vacuum suctioning step vacuum-suctions the top board to a suction surface of a suction table by suctioning the board from above with the interposing member being inserted in the gap.

According to the first aspect, the adhesive member adheres only to a top board among the loaded boards, whereby it is possible to easily separate only the top board from the other boards. Also, only the top board is supported by utilizing the adhesive surface of the adhesive member such that a gap is formed between the top board and the second board, and the interposing member is inserted into the resulting gap. As a result, a gap is formed between the top board and the second board, which are not in close contact with each other, and only the top board is suctioned by the suction table. Thus, even if a plurality of perforations are formed in a board, it is possible to pick up only the top board among a plurality of loaded boards while preventing two or more boards from being picked up at one time. Also, since the board picking up apparatus does not exert intensive stress on the loaded boards, the board can be prevented from being deformed or damaged by selecting an interposing member to be inserted, which is made of a material which does not damage the board. Furthermore, the suction table vacuum-suctions a board to the suction surface, whereby it is not necessary to adjust a position of a suction pad, etc., according to the shape of the board.

According to the second aspect, after the top board adheres to the adhesive member, a relative difference in level between the top board adhering to the adhesive member and the other boards is increased. Thus, it is possible to easily widen a gap for receiving the interposing member, and easily insert the interposing member thereinto.

According to the third aspect, it is possible to facilitate adherence of the adhesive member to the top board, and easily form a gap for receiving the interposing member by utilizing an up-and-down movement of the lifting table.

According to the fourth aspect, the adhesive member supporting section supports the adhesive member in such a manner that a portion thereof faces downward with respect to a rotational direction. Thus, it is possible to forcibly release the board from the adhesive member by rotating the adhesive member supporting section.

According to the fifth aspect, the adhesive surface of the adhesive member is cleansed at a predetermined time, whereby it is possible to recover the adhesive power of the adhesive member.

According to the sixth aspect, a portion of the adhesive surface of the adhesive member to which a board adheres is replaced with any other portion at a predetermined time so as to use a clean portion of the adhesive surface without using the same portion for a long time. Thus, it is possible to maintain adherence of the adhesive member to a board.

According to the seventh aspect, the electrostatic suction member electrostatic-suctions a top board among the loaded boards. As is the case with the adhesive member, the electrostatic suction member electrostatic-suctions only the top board. Thus, it is possible to easily separate only the top board from the other loaded boards by electrostatic suction.

According to the board picking up method of the present invention, it is possible to achieve the same effect as the above-described board picking up apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an elevation view illustrating a schematic structure of a board inspecting apparatus 1 according to one embodiment of the present invention;

FIG. 2 is a top view illustrating a schematic structure of the board inspecting apparatus 1 as shown in FIG. 1;

FIG. 3 is an elevation view illustrating a schematic structure of the board inspecting apparatus 1 with expanding air cylinders 23 and 33;

FIG. 4 is a side view illustrating a schematic internal structure of an air pressure mechanism of the board inspecting apparatus 1 as shown in FIG. 1;

FIG. 5 is a back view illustrating a rotary driving mechanism for rotating a rotational member of the board inspecting apparatus 1 as shown in FIG. 1;

FIG. 6 is a top view illustrating a schematic structure of a board supplying section 7 as shown in FIG. 1;

FIG. 7 is a cutaway side view of the board supplying section 7 as shown in FIG. 1 showing schematically aboard case 71;

FIGS. 8A and 8B are enlarged views each showing an end of an adhesive member arm 73 and an adhesive member 74;

FIG. 9 is a flowchart showing how a board S is supplied to any of A-side inspecting suction tables 22a to 22d from the board supplying section 7 as shown in FIG. 1;

FIG. 10 is a schematic view showing a first stage at which the board supplying section 7 and the A-side inspecting suction table 22 operate according to the flowchart as shown in FIG. 9;

FIG. 11 is a schematic view showing a second stage at which the board supplying section 7 and the A-side inspecting suction table 22 operate according to the flowchart as shown in FIG. 9;

FIG. 12 is a schematic view showing a third stage at which the board supplying section 7 and the A-side inspecting suction table 22 operate according to the flowchart as shown in FIG. 9;

FIG. 13 is a schematic view showing a fourth stage at which the board supplying section 7 and the A-side inspecting suction table 22 operate according to the flowchart as shown in FIG. 9;

FIG. 14 is a schematic view showing a fifth stage at which the board supplying section 7 and the A-side inspecting suction table 22 operate according to the flowchart as shown in FIG. 9;

FIG. 15 is a schematic view showing a sixth stage at which the board supplying section 7 and the A-side inspecting suction table 22 operate according to the flowchart as shown in FIG. 9;

FIG. 16 is a schematic view showing a seventh stage at which the board supplying section 7 and the A-side inspecting suction table 22 operate according to the flowchart as shown in FIG. 9;

FIG. 17 is a schematic view showing an eighth stage at which the board supplying section 7 and the A-side inspecting suction table 22 operate according to the flowchart as shown in FIG. 9;

FIG. 18 is a schematic view showing a ninth stage at which the board supplying section 7 and the A-side inspecting suction table 22 operate according to the flowchart as shown in FIG. 9;

FIG. 19 is a schematic view showing a tenth stage at which the board supplying section 7 and the A-side inspecting suction table 22 operate according to the flowchart as shown in FIG. 9;

FIG. 20 is a schematic view showing an eleventh stage at which the board supplying section 7 and the A-side inspecting suction table 22 operate according to the flowchart as shown in FIG. 9;

FIG. 21 is an illustration showing an exemplary board S;

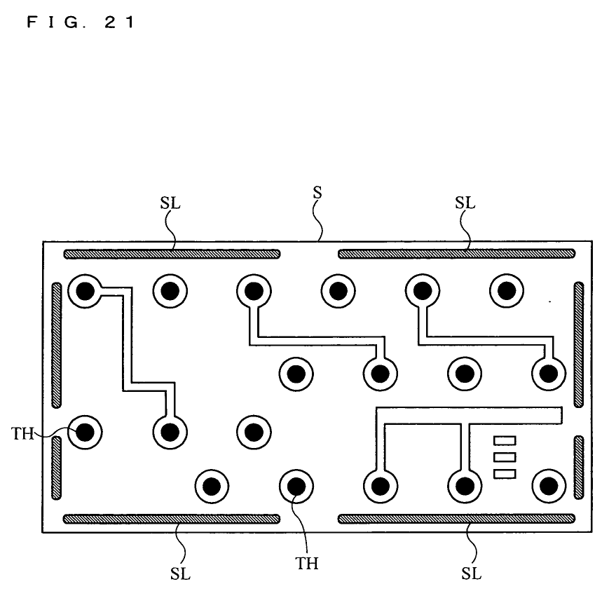

FIGS. 22A and 22B are schematic cross-sectional views each showing a structure of a conventional blower vacuum apparatus;

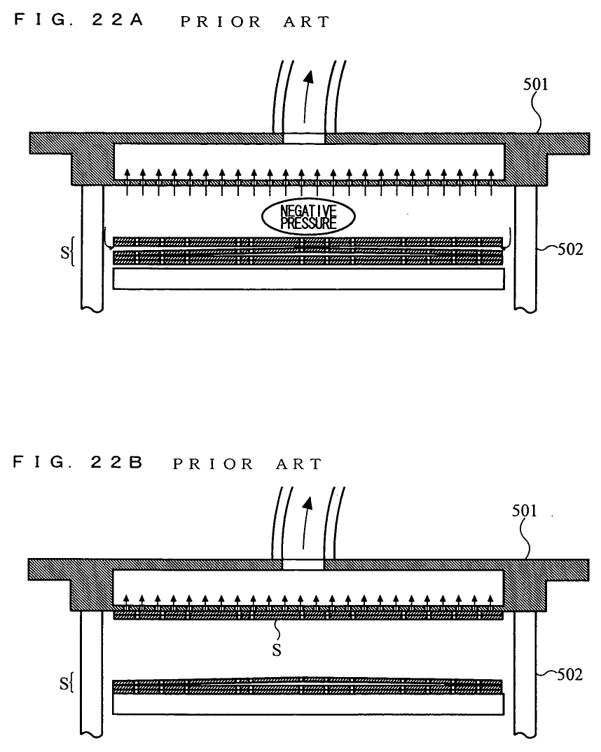

FIG. 23 is a schematic view showing a structure of an adhesive power recovery mechanism 100;

FIG. 24 is a schematic view showing a structure of a cleansing roller 105; and

FIG. 25 is a schematic view showing a structure of an adhesive member replacing mechanism 200 as seen from the side, front, and bottom thereof.

### DESCRIPTION OF THE PREFERRED EMBODIMENTS

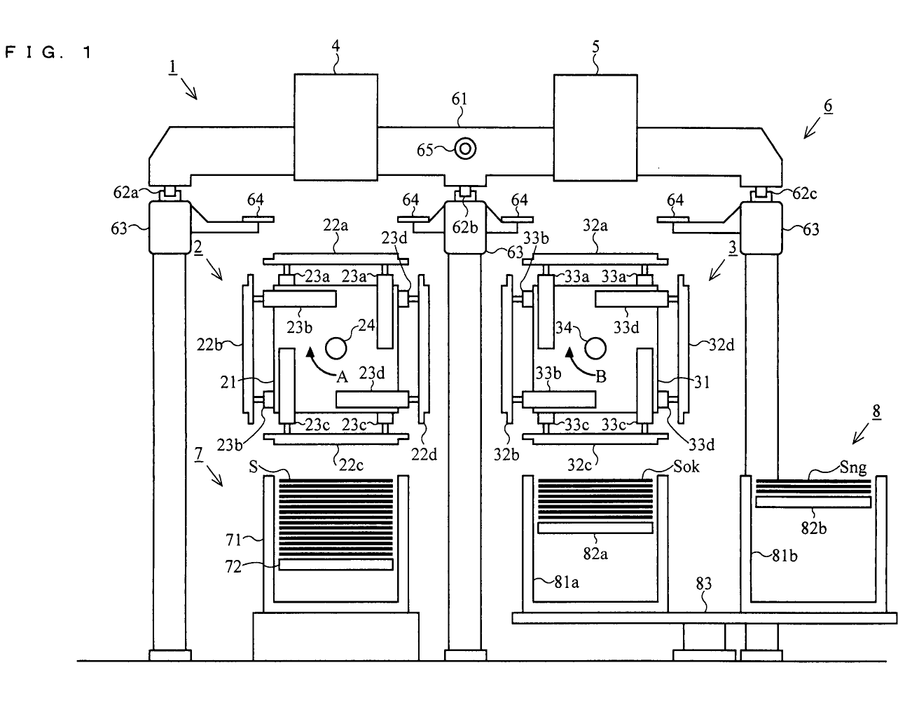

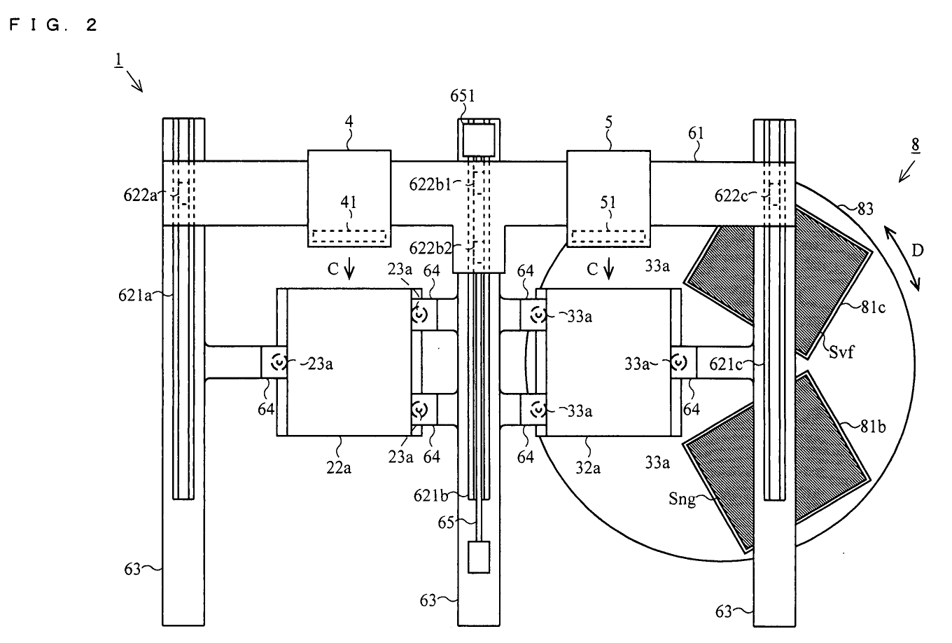

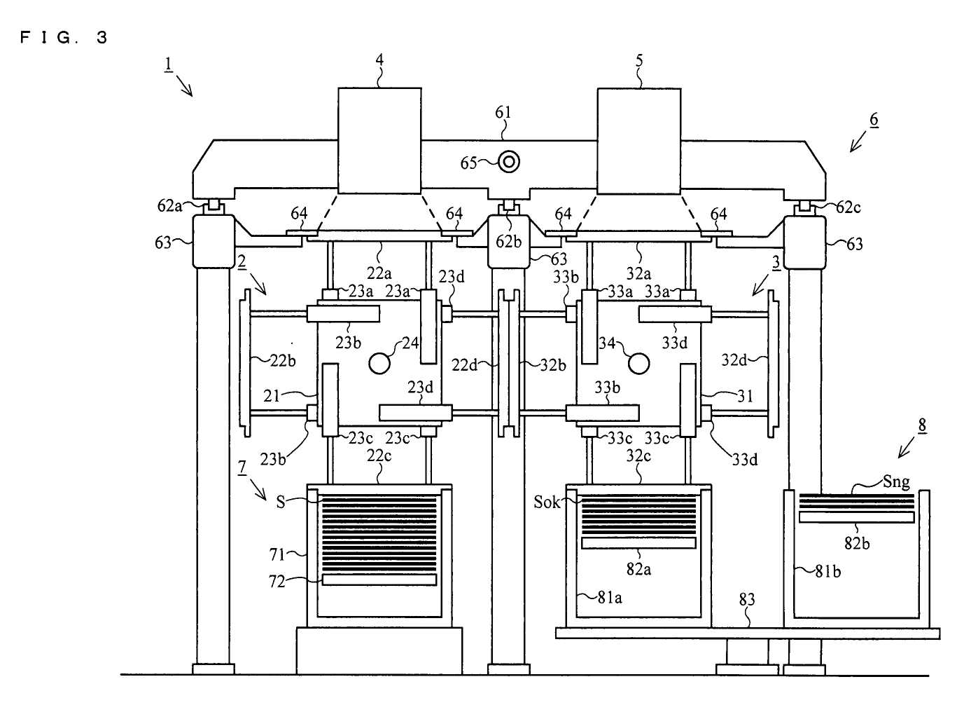

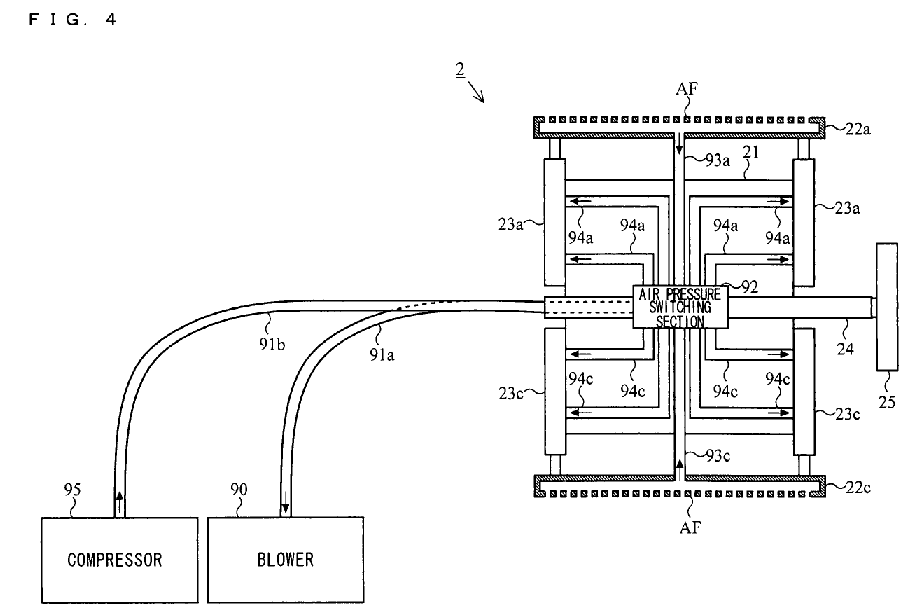

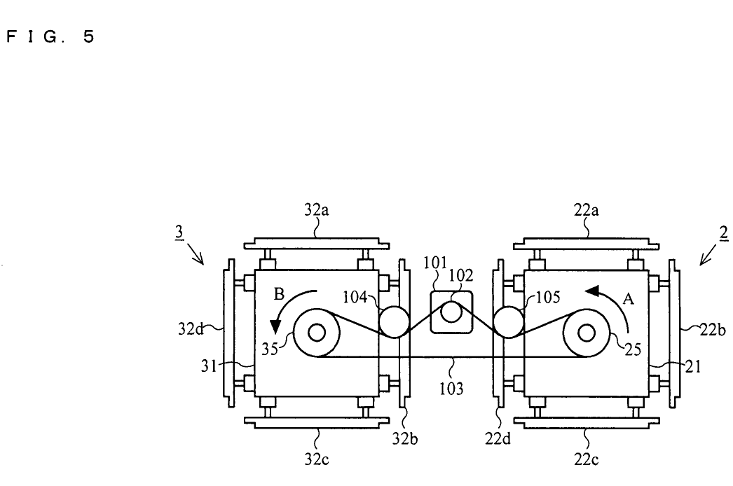

Referring to FIGS. 1 to 5, a board inspecting apparatus 1 according to one embodiment of the present invention will be described. FIG. 1 is an elevation view illustrating a schematic structure of the board inspecting apparatus 1. FIG. 2 is a top view illustrating a schematic structure of the board inspecting apparatus 1. FIG. 3 is an elevation view illustrating a schematic structure of the board inspecting apparatus 1 with expanding air cylinders. FIG. 4 is a side view illustrating a schematic internal structure of an air pressure mechanism of the board inspecting apparatus 1. FIG. 5 is a back view illustrating a rotary driving mechanism for rotating a rotational member of the board inspecting apparatus 1. For clarification of a positional relationship of component elements, not all of the component elements of the board inspecting apparatus 1 are shown in FIGS. 1 to 5.

In FIG. 1, the board inspecting apparatus 1 comprises a first inspection stage 2, a second inspection stage 3, an A-side inspecting head 4, a B-side inspecting head 5, a frame 6, a board supplying section 7, aboard accommodation section 8, and a control section (not shown). A material to be inspected by the board inspecting apparatus 1 is, for example, a printed circuit board for implementing an electronic part (e.g., a semiconductor device) thereon. As described in the Related Art Statement section, a plurality of perforations penetrating through the board such as through-holes TH and slits SL are formed in the board. For instance, the above-described board is a double-sided printed board requiring visual inspection of both sides thereof. Assume that one principal surface of a board to be inspected is referred to as an A-side; the other principal surface is referred to as a B-side.

The first inspection stage 2 includes a first rotational member 21, A-side inspecting suction tables 22, air cylinders 23, and a first rotational axis 24. The first rotational member 21 has the shape of a generally rectangular solid, and is rotatable around the first rotational axis 24 in an A direction in FIG. 1. Four A-side inspecting suction tables 22a to 22d are provided on corresponding four sides of the first rotational member 21, which is parallel to the first rotational axis 24, through the respective air cylinders 23a to 23d. In FIG. 1, the first rotational axis 24 is disposed perpendicularly to the plane of the drawing, and the A-side inspecting suction table 22a is provided immediately above the first rotational axis 24 through three air cylinders 23a (in FIG. 1, only two air cylinders 23a are shown). The A-side inspecting suction table 22b is provided to the left with respect to the first rotational axis 24 through three air cylinders 23b (in FIG. 1, only two air cylinders 23b are shown). The A-side inspecting suction table 22c is provided under the first rotational axis 24 through three air cylinders 23c (in FIG. 1, only two air cylinders 23c are shown). The A-side inspecting suction tables 22a and 22c are disposed so as to be parallel with each other. The A-side inspecting suction table 22d is provided to the right with respect to the first rotational axis 24 through three air cylinders 23d (in FIG. 1, only two air cylinders 23d are shown). The A-side inspecting suction tables 22b and 22d are disposed so as to be parallel with each other.

The second inspection stage 3 and the first inspection stage 2 are arranged in parallel. The second inspection stage 3 includes a second rotational member 31, B-side inspecting suction tables 32, air cylinders 33, and a second rotational axis 34. As is the case with the first rotational member 21, the second rotational member 31 has the shape of a generally rectangular solid, and is rotatable around the second rotational axis 34, which is parallel to the first rotational axis 24, in a B direction in FIG. 1. Four B-side inspecting suction tables 32a to 32d are provided on corresponding four sides of the second rotational member 31, which is parallel to the second rotational axis 34, through the respective air cylinders 33a to 33d. In FIG. 1, the second rotational axis 34 is disposed perpendicularly to the plane of the drawing. The B-side inspecting suction table 32a is provided immediately above the second rotational axis 34 through three air cylinders 33a (in FIG. 1, only two air cylinders 33a are shown). The B-side inspecting suction table 32b is provided on the left side of the second rotational axis 34 through three air cylinders 33b (in FIG. 1, only two air cylinders 33b are shown). The B-side inspecting suction table 32b and the A-side inspecting suction table 22d are disposed so as to be opposed to each other. The B-side inspecting suction table 32c is provided on the lower side of the second rotational axis 34 through three air cylinders 33c (in FIG. 1, only two air cylinders 33c are shown). The B-side inspecting suction tables 32a and 32c are disposed so as to be parallel with each other. The B-side inspecting suction table 32c is provided on the right side of the second rotational axis 34 through three air cylinders 33d (in FIG. 1, only two air cylinders 33d are shown). The B-side inspecting suction tables 32b and 32d are disposed so as to be parallel with each other.

As shown in FIGS. 1 and 2, the frame 6 includes an inspection head beam 61, three linear bearings 62a to 62c, main unit bases 63, contact members 64, and a ball screw 65. The main unit bases 63 are fixed on a plane over the first inspection stage 2 and the second inspection stage 3 by means of predetermined supporting poles. The linear bearings 62a to 62c can be made up in various combinations such as a rail with a slide block, an axis with a bearing or a sleeve, and a rail with a guide; in this embodiment, a rail and a slide block are combined to make up the linear bearing 62. The linear bearings 62a and 62c include rails 621a and 621c, and slide blocks 622a and 622c, respectively; the linear bearing 62b includes a rail 621b and slide blocks 622b1 and 622b2. The rails 621a to 621c are fixed on the upper surface of the main unit bases 63 (in FIG. 2, the rails 621 and the slide blocks 622 lying below the inspection head beam 61 are shown by dashed line). The rails 621a to 621c are fixedly arranged in parallel at predetermined intervals, and the rails 621a and 621c are disposed on both sides of the rail 621b. The first inspection stage 2 is placed in a lower space between the rails 621a and 621b, whereas the second inspection stage 3 is placed in a lower space between the rails 621b and 621c. In an upper space of the rail 621b, the ball screw 65 rotated by a driving force of a linear motor 651 is provided on the main unit base 63 so as to be parallel to the rail 621b. The drive of the linear motor 651 is controlled by the control section. In FIGS. 1 and 2, the main unit bases 63 for supporting the rails 621a to 621c are represented as separate bases in order to clarify a relationship with other component elements. In actuality, the main unit bases 63 are connected to each other with openings being left at least over the first inspection stage 2 and the second inspection stage 3. The plurality of contact members 64 (e.g., three contact members for each opening) are disposed on the same plane, and fixed to the main unit base 63 so as to protrude into the above opening.

The inspection head beam 61 is disposed in a manner of a bridge astride the rails 621a to 621c fixed on the upper surface of the main unit base 63. The slide blocks 622a, 622b1, 622b2, and 622c are provided under the inspection head beam 61. The slide block 622a is movably engaged with the rail 621a, the slide blocks 622b1 and 622b2 are movably engaged with the rail 621b, and the slide block 622c is movably engaged with the rail 621c. The inspection head beam 61 is screwed with the ball screw 65 over the slide blocks 622b1 and 622b2. Thus, the drive of the linear motor 651 rotates the ball screw 65, whereby the inspection head beam 61 moves on the main unit base 63 along a direction in which the rails 621a to 621c are arranged in parallel (a C direction in FIG. 2).

The A-side inspecting head 4 and the B-side inspecting head 5 are disposed on the inspection head beam 61. The A-side inspecting head 4 and the B-side inspecting head 5 each comprise an imaging apparatus (not shown) such as a CCD camera, and take an image of a space under the inspection head beam 61 through slits 41 and 51 (shown by dashed line in FIG. 2) opened in the lower portion of the imaging apparatuses. The A-side inspecting head 4 is disposed on the inspection head beam 61 between the slide block 622a and the slide blocks 622b1 and 622b2. Specifically, in the case where the A-side inspecting suction table 22 of the first inspection stage 2 is fixed in a position so as to be in contact with the contact member 64, the inspection head beam 61 moves in the C direction in FIG. 2 such that the A-side inspecting head 4 is disposed at a position where the imaging apparatus of the A-side inspecting head 4 can take an image of a board S suctioned to the A-side inspecting suction table 22, which will be described below in detail. Also, the B-side inspecting head 5 is disposed on the inspection head beam 61 between the slide block 622b1 and 622b2 and the slide block 622c. Specifically, in the case where the B-side inspecting suction table 32 of the second inspection stage 3 is fixed on a position so as to be in contact with the contact member 64, the inspection head beam 61 moves in the C direction in FIG. 2 such that the B-side inspecting head 5 is disposed at a position where the imaging apparatus of the B-side inspecting head 5 can take an image of a board S suctioned to the B-side inspecting suction table 32.

The board supplying section 7 is disposed in a space immediately under the first inspection stage 2. The board supplying section 7 comprises an open-topped board case 71 and a lifting table 72. The lifting table 72 is provided in the board case 71. A board S to be inspected by the board inspecting apparatus 1 is loaded on the lifting table 72 in the board case 71. The lifting table 72 moves up and down based on control by the control section, for example, so as to keep a level of the top board S constant. Note that a pre-inspected board S to be supplied to the board supplying section 7 is loaded in the board case 71 with the A-side (one principal surface) down. In the case where the A-side inspecting suction table 22 of the first inspection stage 2 moves downward, an outer edge of the A-side inspecting suction table 22 comes in contact with an upper end of the board case 71, whereby the suction surface of the A-side inspecting suction table 22 is placed on the opening of the board case 71, which will be described below in detail.

The board accommodation section 8 comprises three board cases 81a to 81c, three lifting tables 82a to 82c, and a turntable 83. The lifting tables 82a to 82c are provided in the respective board cases 81a to 81c, and a board S inspected by the board inspecting apparatus 1 is loaded on the lifting tables 82a to 82c in the board cases 81a to 81c. The lifting tables 82a to 82c move up and down based on the control by the control section, for example, so as to keep a level of the top board S constant. Specifically, a board S inspected by the board inspecting apparatus 1 is loaded in the board cases 81a to 81c according to the inspection result as follows: a board Sok whose A- and B-sides have passed the inspection by the board inspecting apparatus 1 is loaded in the board case 81a; a board Sng whose A- and B sides have not passed the inspection by the board inspecting apparatus 1 is loaded in the board case 81b; and a board Svf whose A- and/or B-side need to be re-inspected by the board inspecting apparatus 1 is loaded in the board case 81c. The board cases 81a to 81c are placed on the rotary surface of the turntable 83. The turntable 83 is controlled by the control section so as to rotate in a D direction and stop at an appropriate position, whereby any one the board cases 81a to 81c is disposed immediately under the second inspection stage 3. The inspected boards Sok, Sng, and Svf to be accommodated in the board accommodation section 8 are loaded in the respective board cases 81a to 81c with A-side up. In the case where the B-side inspecting suction table 32 of the second inspection stage 3 moves downward, an outer edge of the B-side inspecting suction table 32 comes in contact with an upper end of any one the board cases 81a to 81c lying immediately thereunder, whereby the suction surface of the B-side inspecting suction table 32 is placed on an opening of any one of the board cases 81a to 81c, which will be described below in detail.

Next, referring to FIGS. 1 to 3, the extension and retraction of the air cylinders 23 and 33 provided respectively in the first inspection stage 2 and the second inspection stage 3 will be described.

As aforementioned, the air cylinders 23a to 23d for respectively supporting the A-side inspecting suction tables 22a to 22d are provided in the first rotational member 21. The air cylinders 23a to 23d are extendable by the control of the control section. The air cylinders 23a to 23d extend or retract to change a distance between the respective supporting A-side inspecting suction tables 22a to 22d and the first rotational axis 24. FIG. 1 shows the retracted air cylinders 23a to 23d. In FIG. 1, each of the A-side inspecting suction tables 22a to 22d is disposed in the neighborhood of the side of the first rotational member 21. FIG. 3 shows the extended air cylinders 23a to 23d. In FIG. 3, each of the A-side inspecting suction tables 22a to 22d is disposed is a position away from the first rotational member 21.

As shown in FIGS. 2 and 3, when the air cylinder 23a is extended, the A-side inspecting suction table 22a provided immediately above the first rotational axis 24 is positioned in place in such a manner that an upper surface of the outer edge thereof (an outer surface of the A-side inspecting suction table 22a with respect to the first rotational axis 24) comes in contact with the contact member 64. Hereinafter, a position of the A-side inspecting suction table 22 being in contact with the contact member 64 is referred to as an A-side inspection position. As shown in FIG. 2, in the present example, a position (three positions) to which the contact member 64 is fixed is set so as to coincide with a position (three positions) at which the air cylinder 23a supports the A-side inspecting suction table 22a in order to stably position the A-side inspecting suction table 22a at the A-side inspection position.

As shown in FIG. 3, when the air cylinder 23c is extended, a lower surface of the outer edge of the A-side inspecting suction table 22c (an outer surface of the A-side inspecting suction table 22c with respect to the first rotational axis 24) provided under the first rotational axis 24 comes in contact with the upper end of the board case 71 of the board supplying section 7, and the suction surface of the A-side inspecting suction table 22c is placed on the opening of the board case 71. Hereinafter, a position of the A-side inspecting suction table 22 placed on the opening of the board case 71 is referred to as a board supplying position.

Also, as shown in FIG. 3, when the air cylinder 23d is extended, the suction surface of the A-side inspecting suction table 22d provided to the right with respect to the first rotational axis 24 comes in contact with the suction surface of the B-side inspecting suction table 32b supported by the extended air cylinder 33b. Hereinafter, a position at which the suction surface of the A-side inspecting suction table 22 is in contact with the suction surface of the B-side inspecting suction table 32 is referred to as a board passing position.

The air cylinders 33a to 33d for respectively supporting the B-side inspecting suction tables 32a to 32d are provided in the second rotational member 31. The air cylinders 33a to 33d are extendable by the control of the control section. The air cylinders 33a to 33d extend or retract to change a distance between the respective supporting B-side inspecting suction tables 32a to 32d and the second rotational axis 34. FIG. 1 shows the retracted air cylinders 33a to 33d. In FIG. 1, each of the B-side inspecting suction tables 32a to 32d is disposed in the neighborhood of the side of the second rotational member 31. FIG. 3 shows the extended air cylinders 33a to 33d. In FIG. 3, each of the B-side inspecting suction tables 32a to 32d is disposed at a position away from the second rotational member 31.

As shown in FIGS. 2 and 3, when the air cylinder 33a is extended, the B-side inspecting suction table 32a provided immediately above the second rotational axis 34 is positioned in place in such a manner that an upper surface of the outer edge thereof (an outer surface of the B-side inspecting suction table 32a with respect to the second rotational axis 34) comes in contact with the contact member 64. Hereinafter, a position of the B-side inspecting suction table 32 being in contact with the contact member 64 is referred to as a B-side inspection position. As shown in FIG. 2, in the present example, a position (three positions) to which the contact member 64 is fixed is set to so as to coincide with a position (three positions) at which the air cylinder 33a supports the B-side inspecting suction table 32a in order to stably position the B-side inspecting suction table 32a at the B-side inspection position.

Also, as shown in FIG. 3, when the air cylinder 33c is extended, a lower surface of the outer edge of the B-side inspecting suction table 32c (an outer surface of the B-side inspecting suction table 32c with respect to the second rotational axis 34) provided under the second rotational axis 34 comes in contact with the upper end of any one of the board cases 81a to 81c of the board accommodation section 8, and the suction surface of the B-side inspecting suction table 32c is placed on the opening of any one of the board cases 81a to 81c. Hereinafter, a position of the B-side inspecting suction table 32 placed on the opening of the board case 81 is referred to as a board ejection position.

Furthermore, as shown in FIG. 3, when the air cylinder 33b is extended, the suction surface of the B-side inspecting suction table 32b provided to the left with respect to the second rotational axis 34 comes in contact with the suction surface of the A-side inspecting suction table 22d supported by the extended air cylinder 23d. Hereinafter, a position at which the suction surface of the B-side inspecting suction table 32 is in contact with the suction surface of the A-side inspecting suction table 22 is referred to as a board passing position.

Next, referring to FIG. 4, an air pressure mechanism of the board inspecting apparatus 1 will be described. FIG. 4 shows only an air pressure mechanism on the side of the first inspection stage 2, and an air pressure mechanism on the side of the second inspection stage 3 is implemented in the same manner as in the first inspection stage 2. Thus, the air pressure mechanism on the side of the first inspection stage 2 will be exemplarily described. For description of the air pressure mechanism on the side of the first inspection stage 2, FIG. 4 omits a portion of the structure of the first inspection stage 2, and shows the A-side inspecting suction table 22 in cross section.

In FIG. 4, the air pressure mechanism of the board inspecting apparatus 1 comprises a blower 90, a compressor 95, a main pipe 91a, a main pipe 91b, an air pressure switching section 92, suction pipes 93, and cylinder pipes 94. The first rotational axis 24 supports the air pressure switching section 92 inside the first rotational member 21. The air pressure switching section 92 has a plurality of switching valves controlled by the control section. A hollow path penetrating from one end of the first rotational axis 24 to each switching valve (shown in dashed line in FIG. 4) is formed in the first rotational axis 24. At the other end of the first rotational axis 24, a timing pulley 25 is fixed. The main pipe 91a passing through the hollow path of the first rotational axis 24 connects between the blower 90 and the air pressure switching section 92, so as to supply the A-side inspecting suction tables 22a to 22d with air pressure generated by the blower 90 via the air pressure switching section 92. Similarly, the main pipe 91b passing through the hollow path of the first rotational axis 24 connects between the compressor 95 and the air pressure switching section 92, so as to supply the air cylinders 23a to 23d with air pressure generated by the compressor 95 via the air pressure switching section 92.

A plurality of suction holes are formed in a suction surface AF of each of the A-side inspecting suction tables 22a to 22d (in FIG. 4, only the A-side inspecting suction tables 22a and 22c are shown). Also, the suction pipes 93a to 93d, which are extendable as the respective air cylinders 23a to 23d extend or retract (in FIG. 4, only the suction pipes 93a and 93c are shown), are connected between the corresponding A-side inspecting suction tables 22a to 22d and the switching valve of the air pressure switching section 92. Note that the suction pipes 93a to 93d are connected to different switching valves. The air pressure (negative pressure) supplied to the A-side inspecting suction tables 22a to 22d via the corresponding suction pipe 93a to 93d is released through the suction holes formed in the A-side inspecting suction tables 22a to 22d. That is, in the case where the negative pressure is supplied to the A-side inspecting suction tables 22a to 22d via the corresponding suction pipes 93a to 93d based on the control of the control section, the negative pressure occurs in each suction hole, whereby vacuum suction utilizing the suction surface AF is realized.

The cylinder pipes 94a to 94d are connected between the respective air cylinders 23a to 23d and the switching valve of the air pressure switching section 92 (in FIG. 4, only the cylinder pipes 94a and 94c are shown). The air pressure (positive pressure) is supplied to the cylinder pipes 94a to 94d from the compressor 95 based on the control of the control section, whereby the extension or retraction of the air cylinders 23a to 23d is realized. The air pressure mechanism on the side of the second inspection stage 3 operates in the same manner as that of the first inspection stage 2, and the detailed description there of is omitted. Note that a timing pulley 35 is fixed on the other end of the second rotational axis 34 of the second inspection stage 3. In the above-described embodiment, the air pressure switching section 92 switches between air pressures supplied from the blower 90 and the compressor 95, but separate switching sections may be provided.

Next, referring to FIG. 5, a rotary driving mechanism for rotating the first rotational member 21 and the second rotational member 31 of the board inspecting apparatus 1 will be described. FIG. 5 is a back view illustrating a portion of the board inspecting apparatus 1. Note that a positional relationship and a rotational direction of the first inspection stage 2 and the second inspection stage 3 as shown in FIG. 5 are reversed left to right relative to the equivalent inspection stages as shown in FIGS. 1 and 3.

In FIG. 5, the rotary driving mechanism for rotating the first rotational member 21 and the second rotational member 31 includes a rotational driving motor 101, a timing belt 103, and tension pulleys 104 and 105. A pulley 102 is fixed to a rotational axis of the rotational driving motor 101. Based on the control of the control section, the rotational driving motor 101 drives the pulley 102 by a predetermined rotation angle. The timing belt 103 rotatably runs over the pulley 102 and the timing pulleys 25 and 35 via the tension pulleys 104 and 105. The tension pulleys 104 and 105 control the tension of the timing belt 103 running over the pulleys. A driving force of the rotational driving motor 101 rotates the timing pulleys 25 and 35 so as to be in synchronization with each other by the same rotation angle via the timing belt 103, thereby rotating the first rotational axis 24 and the second rotational axis 34 to which the timing pulleys 25 and 35 are respectively fixed. In response to the rotation of the first rotational axis 24 and the second rotational axis 34, the first rotational member 21 and the second rotational member 31 rotate in the A and B directions in FIG. 5, respectively. In the present example, the first rotational member 21 and the second rotational member 31 rotate by 90 degrees in the A and B directions in FIG. 5, respectively, in response to an instruction from the control section.

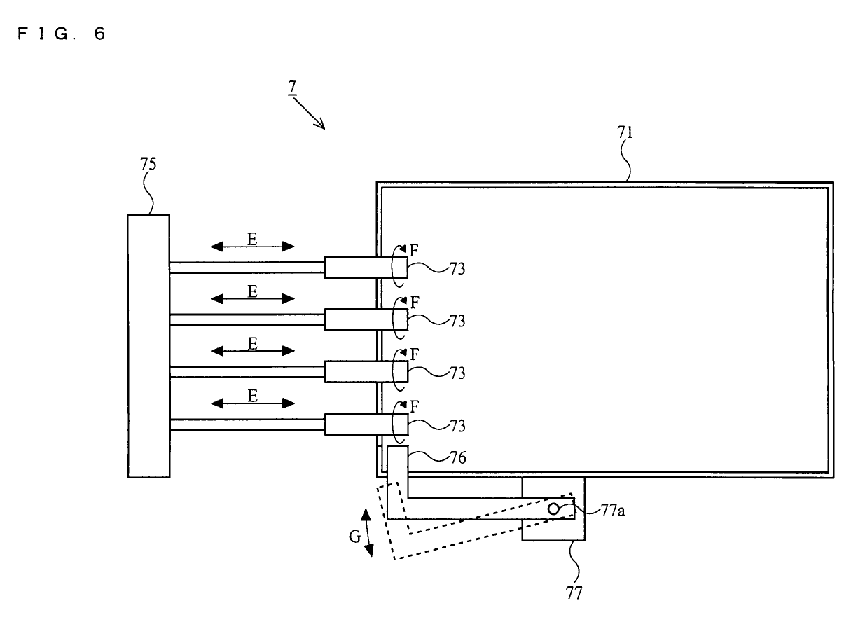

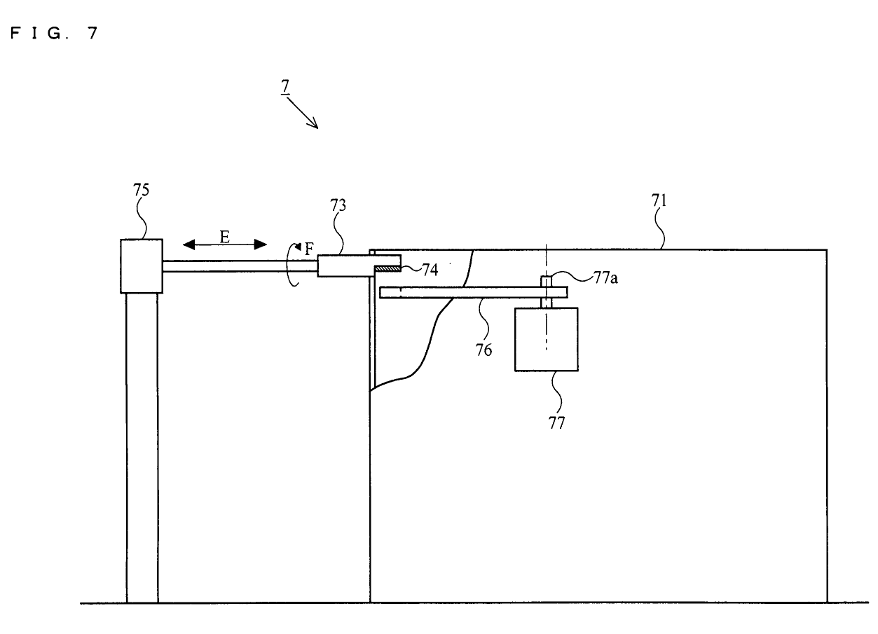

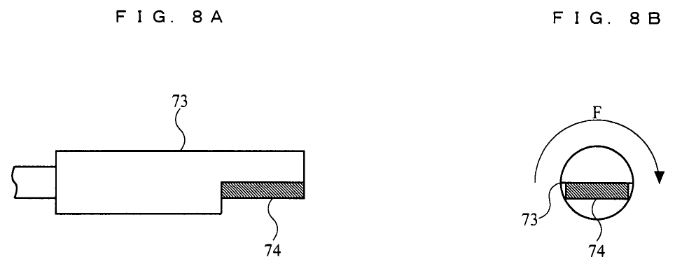

Next, referring to FIGS. 6 to 8, a detailed structure of the board supplying section 7 will be described. FIG. 6 is a top view illustrating a schematic structure of the board supplying section 7. FIG. 7 is a cutaway side view of the board supplying section 7 showing schematically the board case 71. FIGS. 8A and 8B are enlarged views each showing an end of an adhesive member arm 73 and an adhesive member 74. Roughly speaking, the board picking up apparatus of the present invention is implemented by the board supplying section 7 and the A-side inspecting suction table 22 performing blower suction.

In FIGS. 6 and 7, the board supplying section 7 includes the adhesive member arms 73, the adhesive members 74, actuators 75 and 77, and an interposing member 76 other than the above-described board case 71 and the lifting table (see FIG. 1). A plurality of adhesive member arms 73 are transversely provided so as to be parallel with each other in the neighborhood of the side of the opening of the board case 71, and the adhesive member 74 is attached to the end of each adhesive member arm 73. The adhesive member arm 73 is implemented by the actuator 75 including an air cylinder, a motor, and the like, so as to be linearly movable in a direction of the long axis of the arm (an E direction in FIG. 7). The adhesive member arm 73 moves linearly such that a portion to which the adhesive member 74 is attached protrudes into/retracts away from the opening of the board case 71. In FIGS. 6 and 7, a portion to which the adhesive member 74 is attached protrudes into the opening of the board case 71. Also, the adhesive member arm 73 is implemented by the actuator 75 so as to be rotatably movable in a rotational direction around the arm axis (an F direction in FIG. 7). A driving of the actuator 75 is controlled by the control section of the board inspecting apparatus 1.

The interposing member 76 is a plate member, such as a Teflon (R) sheet, made of fluorocarbon resin. For example, the interposing member 76 is an L-shaped plate member of 175 μm (micrometers) in thickness, and one end thereof is fixed to a rotational axis 77a of the actuator 77 fixed to the board case 71. The interposing member 76 is implemented by the actuator 77 including an air cylinder, a motor, and the like, so as to be rotatably movable in a rotational direction around the rotational axis 77a (a G direction in FIG. 6). By the above-described rotation, the other end of the interposing member 76 protrudes into (as shown in solid line in FIG. 6)/retracts away from (as shown in dashed line in FIG. 6) the board case 71. As shown in FIG. 7, the other end of the interposing member 76 protruding into the board case 71 is located at least below the end of the adhesive member arm 73 protruding into the opening of the board case 71. A driving of the actuator 77 is controlled by the control section of the board inspecting apparatus 1.

Next, referring to FIG. 8, the detailed structure of the end of the adhesive member arm 73 and the adhesive member 74 will be described. As shown in FIG. 8, the adhesive member arm 73 has a generally cylindrical shape. The end of the adhesive member arm 73 is cut so as to have a D shape in cross section (D-cut). The adhesive member 74 is attached to the cut end portion of the adhesive member arm 73. As aforementioned, the adhesive member arm 73 is implemented by the actuator 75 so as to be rotatably movable in a rotational direction around the arm axis (the F direction in FIG. 8). By this rotation, the adhesive member arm 73 is either located with the adhesive member 74 facing downward (the adhesive member 74 as shown in FIG. 8 is in this state), or with the adhesive member 74 facing upward and the side of the adhesive member arm 73 facing downward (such a state is obtained by rotating the adhesive member arm 73 as shown in FIG. 8 by 180 degrees in the F direction).

A washable pressure sensitive adhesive sheet for transfer purposes (e.g., a TechniClean(R) AD sheet produced by Audio-Technica Cooperation) or other adhesive members (e.g., resin including soft rubber and acrylic pressure sensitive adhesive) are used as the adhesive member 74. In the case where the adhesive member 74 has low reusability, an adhesive power recovery mechanism for recovering the adhesive power of the adhesive member 74 or an adhesive member replacing mechanism for reloading with fresh adhesive tape (e.g., by unwinding a roll or rewinding the tape) may be additionally provided.

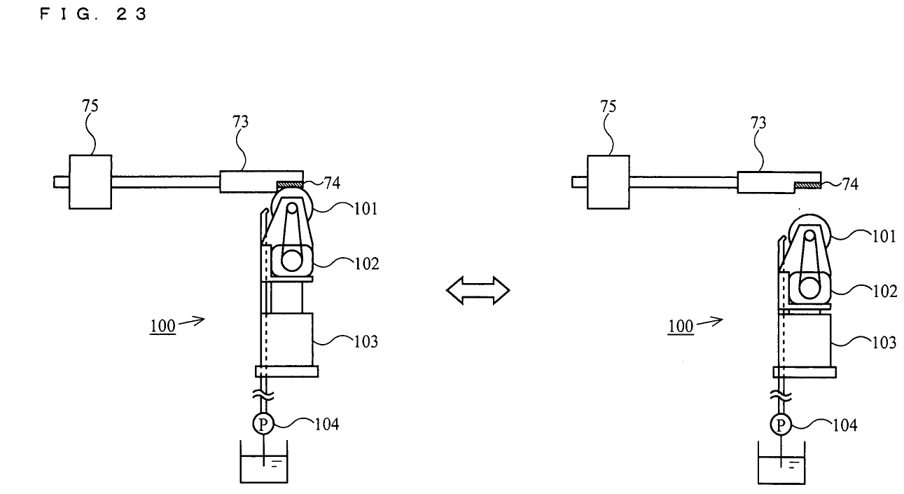

For instance, FIG. 23 is a schematic view showing a structure of an adhesive power recovery mechanism 100. The adhesive power recovery mechanism 100 corresponds to one example of the adhesive power recovery means of the present invention. In FIG. 23, the adhesive power recovery mechanism 100 comprises a cleansing roller 101, a driving motor 102, a lifting section 103, and a cleansing fluid supplying section 104. The cleansing roller 101, which has a cylindrical outer surface to which a brush, a sponge, a cloth or the like is attached, is supported by a bearing so as to be rotatably movable around its cylindrical axis. The driving motor 102, which is fixed to a bracket, rotates the cleansing roller 101 around the cylindrical axis via a timing belt, etc. The cleansing fluid supplying section 104 provides the cylindrical outer surface of the cleansing roller 101 with cleansing fluid (e.g., water) via a nozzle, etc. The lifting section 103 moves up and down the bracket supporting the driving motor 102 and the bearing supporting the cleansing roller 101 by utilizing an electromagnetic solenoid or an air cylinder as a drive source. The above-described up-and-down movement by the lifting section 103 enables the cylindrical outer surface of the cleansing roller 101 to come in contact with or be apart from the adhesive surface of the adhesive member 74. Note that the left drawing of FIG. 23 shows the cylindrical outer surface of the cleansing roller 101 coming in contact with the adhesive surface of the adhesive member 74, whereas the right drawing of FIG. 23 shows the cylindrical outer surface of the cleansing roller 101 being away from the adhesive surface of the adhesive member 74.

At a predetermined time, the adhesive power recovery mechanism 100 causes the cylindrical outer surface of the cleansing roller 101 to come in contact with the adhesive member 74, thereby cleansing the adhesive surface of the adhesive member 74. Specifically, at an appropriate time when the adhesive member arm 73 is in a waiting state (e.g., every time a predetermined number of boards S are processed, a type of board S is changed, or a predetermined time has elapsed), the lifting section 103 moves up such that the cleansing roller 101 comes in contact with the adhesive member 74. While the driving motor 102 rotates the cleansing roller 101, the cleansing fluid supplying section 104 provides the cylindrical outer surface of the cleansing roller 101 with cleansing fluid. As a result, it is possible to recover the adhesive power of the adhesive member 74 by cleansing the adhesive surface thereof.

Note that it is preferable that the cleansing roller 101 and the adhesive member 74 have a plane contact rather than a point contact or a line contact. For example, implanting bristles of brush, etc., in the cylindrical outer surface of the cleansing roller 101 allows the cleansing roller 101 to have a plane contact with the adhesive member 74. Thus, an area in which the cleansing roller 101 is in contact with the adhesive member 74 is increased, whereby it is possible to cleanse a larger area compared to the case of using a point contact or a line contact.

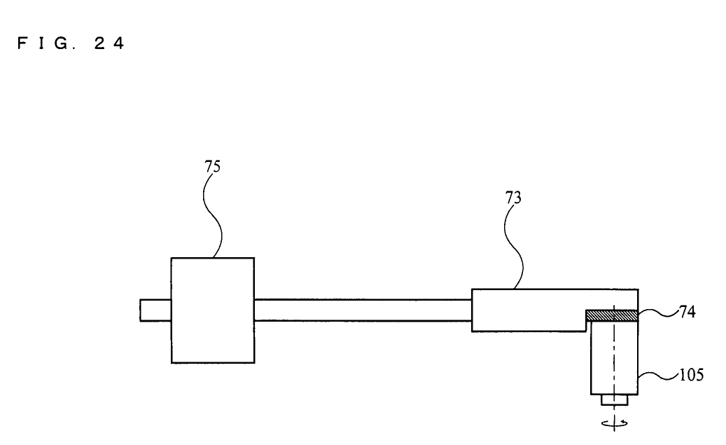

Also, as shown in FIG. 24, a cylindrical cleansing roller 105 whose one end comes in contact with the adhesive member 74 may be used. In this case, the cleansing roller 105 is disposed in such a manner that its cylindrical axis is perpendicular to the adhesive surface of the adhesive member 74, and one end of the cleansing roller 105 comes in contact with the adhesive surface of the adhesive member 74. While one end of the cleansing roller 105 is in contact with the adhesive member 74, the driving motor 102 (not shown in FIG. 24) rotates the cleansing roller 105 around the cylindrical axis, thereby cleansing the adhesive surface. In this case, the cleansing fluid supplying section 104 (not shown in FIG. 24) provides one end of the cleansing roller 105 with cleansing fluid. As long as the adhesive surface of the adhesive member 74 can be cleansed at an appropriate time, the adhesive power recovery mechanism 100 may have another structure.

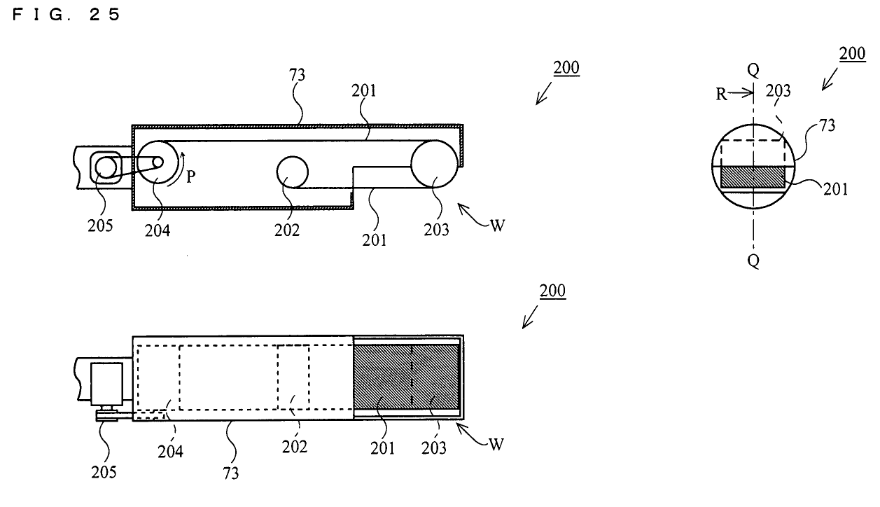

FIG. 25 is a schematic view showing a structure of an adhesive member replacing mechanism 200 as seen from the side, front, and bottom thereof. Note that the side view of the adhesive member replacing mechanism 200 as shown in FIG. 25 shows the internal structure of the adhesive member arm 73 taken along the line Q-Q and as seen from an R direction as shown in the front view of FIG. 25. The adhesive member replacing mechanism 200 corresponds to one example of the adhesive member replacing means of the present invention.

In FIG. 25, the adhesive member replacing mechanism 200 comprises a tape-like adhesive member 201, a supplying roll 202, an end roller 203, a rewinding roll 204, and a rewinding motor 205. In the exemplary structure as shown in FIG. 25, the adhesive member arm 73 has a hollow body whose portion is opened as an opening portion W, and contains at least the adhesive member 201, the supplying roll 202, the end roller 203, and the rewinding roll 204 therein.

The adhesive member replacing mechanism 200 uses the tape-like adhesive member 201 whose one principal surface is adhesive. The adhesive member replacing mechanism 200 rotates the rewinding roll 204 for rewinding the adhesive member 201 in a P direction in FIG. 25 via a timing belt, etc., by a driving of the rewinding motor 205, thereby sequentially unwinding an unused portion of the adhesive member 201 from the supplying roll 202. The adhesive member 201 unwound from the supplying roll 202 runs between the supplying roll 202 and the end roller 203 provided at an end of the adhesive member arm 73. The adhesive surface of the adhesive member 201 is exposed to the outside from the opening portion W. As shown in FIG. 25, a positional relationship of the adhesive member arm 73 and the adhesive member 201 exposed to the outside from the opening portion W is the same as that of the adhesive member arm 73 and the adhesive member 74, which has been described by utilizing FIG. 8. The adhesive member 201 unwound from the supplying roll 202 runs between the supplying roll 202 and the rewinding roll 204 via the end roller 203. The supplying roll 202 is biased by a spring, etc., in a direction opposed to an unwinding direction of the adhesive member 201, and the adhesive member 201 is unwound against the biasing force by the driving force of the rewinding motor 205. The adhesive member replacing mechanism 200 rotates the rewinding motor 205 by a predetermined amount such that a clean adhesive surface is exposed from the opening portion W at the above-described appropriate time. Note that the adhesive member 201 may be a loop-shaped member such that a clean adhesive surface is displaced to the outside by a movement of the adhesive member 201. In the exemplary structure as shown in FIG. 25, the rewinding motor 205 is placed outside the hollow space of the adhesive member arm 73. However, the rewinding motor 205 may be placed inside the hollow space of the adhesive member arm 73, or the rewinding motor 205 may directly drive the rewinding roll 204.

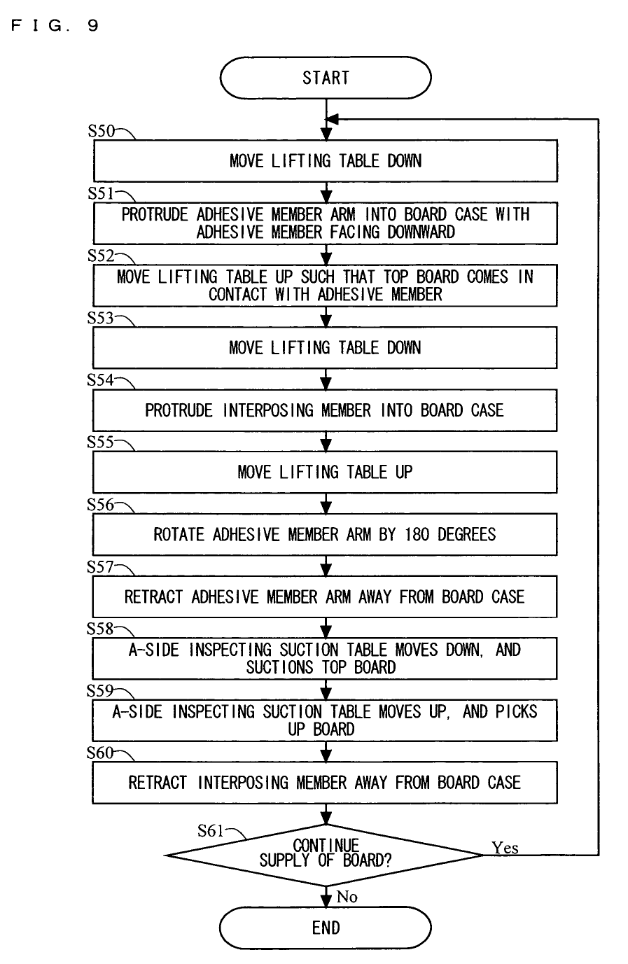

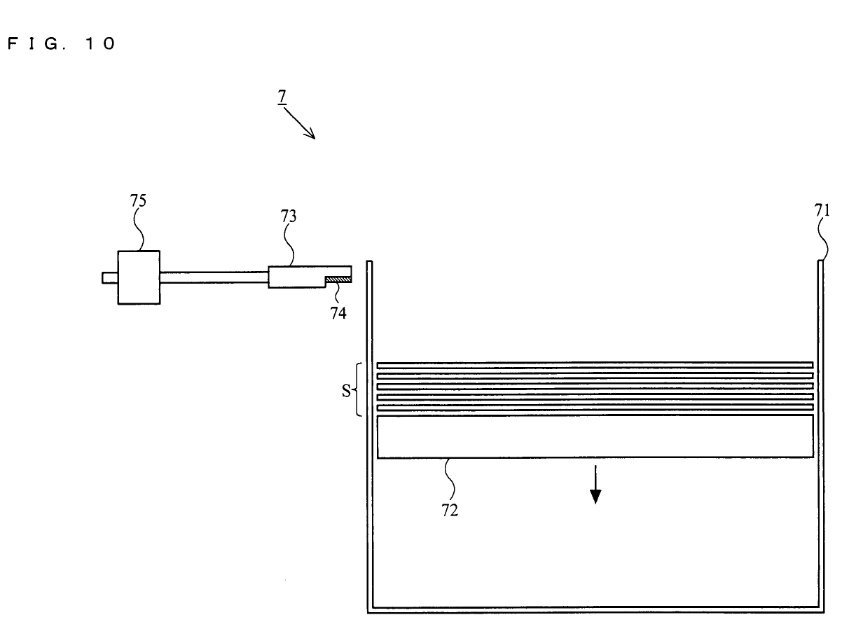

Next, referring to FIGS. 9 to 20, an operation of the board inspecting apparatus 1 will be described. FIG. 9 is a flowchart showing how a board S is supplied to any of the A-side inspecting suction tables 22a to 22d from the board supplying section 7 of the board inspecting apparatus 1. FIGS. 10 to 20 are schematic views each showing how the board supplying section 7 and the A-side inspecting suction table 22 operate according to the flowchart as shown in FIG. 9.

In FIG. 9, the control section of the board inspecting apparatus 1 moves down the lifting table 72 of the board supplying section 7 whose board case 71 contains a plurality of boards S loaded therein (step S50; the board supplying section 7 as shown in FIG. 10 is in this state). The control section moves down the lifting table 72 until the top board S loaded in the board case 71 is located at least below the position of the adhesive member arm 73.

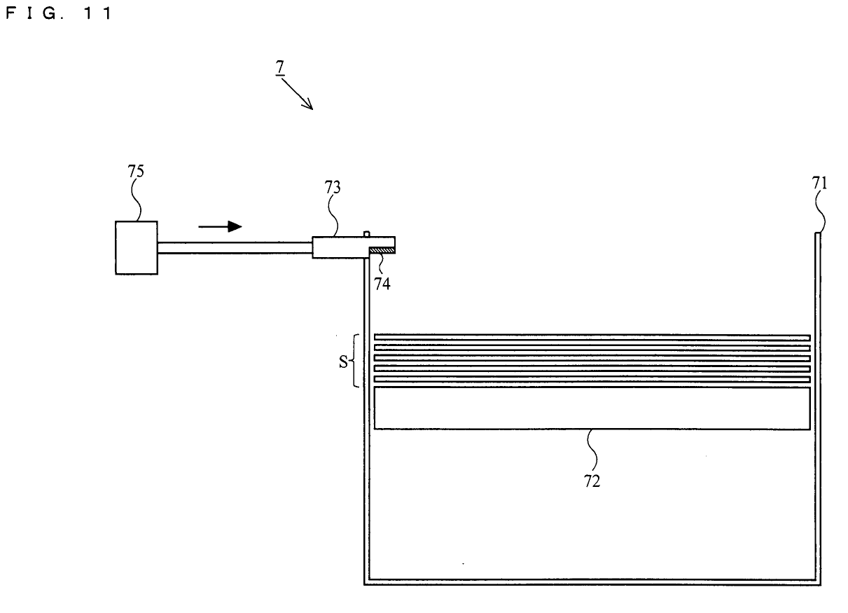

Next, the control section of the board inspecting apparatus 1 drives the actuator 75 so as to protrude the adhesive member arm 73 into the board case 71 with the adhesive member 74 facing downward (see FIG. 8) (step S51; the board supplying section 7 as shown in FIG. 11 is in this state). The control section protrudes the plurality of adhesive member arms 73 arranged in parallel into the board case 71 in the same manner as described above (see FIG. 6).

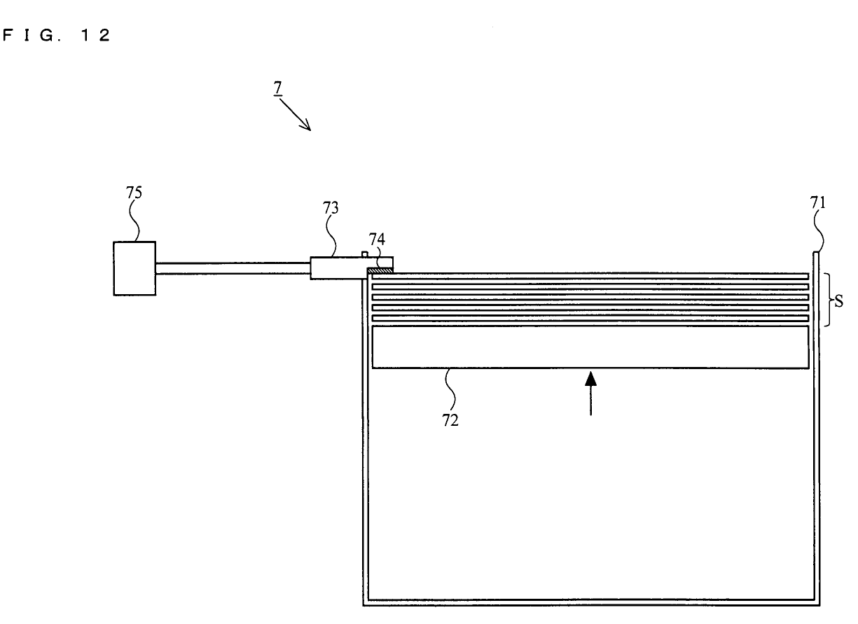

Next, the control section of the board inspecting apparatus 1 moves up the lifting table 72 of the board supplying section 7 such that the top surface of the board S placed on the top of the loaded boards S comes in contact with the adhesive member 74 (step S52; the board supplying section 7 as shown in FIG. 12 is in this state). As a result, the adhesive member 74 adheres to a portion of the top surface of the board S placed on the top of the loaded boards S, whereby the top board S is supported at its one end by the adhesive member arm 73 via the adhesive member 74.

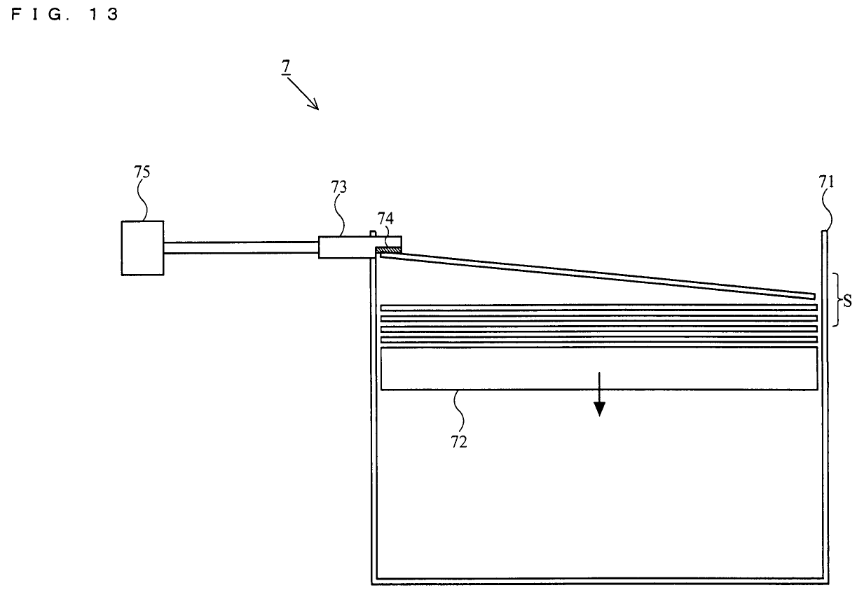

Next, the control section of the board inspecting apparatus 1 moves down the lifting table 72 of the board supplying section 7 from a position in which the board S is in contact with the adhesive member 74 by a predetermined distance (step S53; the board supplying section 7 as shown in FIG. 13 is in this state). As a result, although all the loaded boards S are moved down by the predetermined distance, a gap formed between the top board S and the other boards S lying thereunder is widened since only the top board S is supported at its one end by the adhesive member arm 73 via the adhesive member 74. In other words, the top board S is separated from the other loaded boards S. Note that the control section moves down the lifting table 72 until the second board S loaded in the board case 71 is located at least below the position of the interposing member 76.

In the operation at step S53, the top board S may adhere to the board(s) S lying under the top board S. In order to facilitate separation of the top board S from the board S lying thereunder, an up-and-down movement of the lifting table 72 may be repeated, or the adhesive member arm 73 may be shaken (a so-called “shaking-off” operation), for example. Also, separation of the top board S from the board S lying thereunder may be facilitated by utilizing the tab for preventing two boards from being supplied at one time, which has been described in the Related Art Statement section. Alternatively, separation of the top board S from the board S lying thereunder may be facilitated by spraying the separation air into the board case 71 from the left direction of FIG. 13.

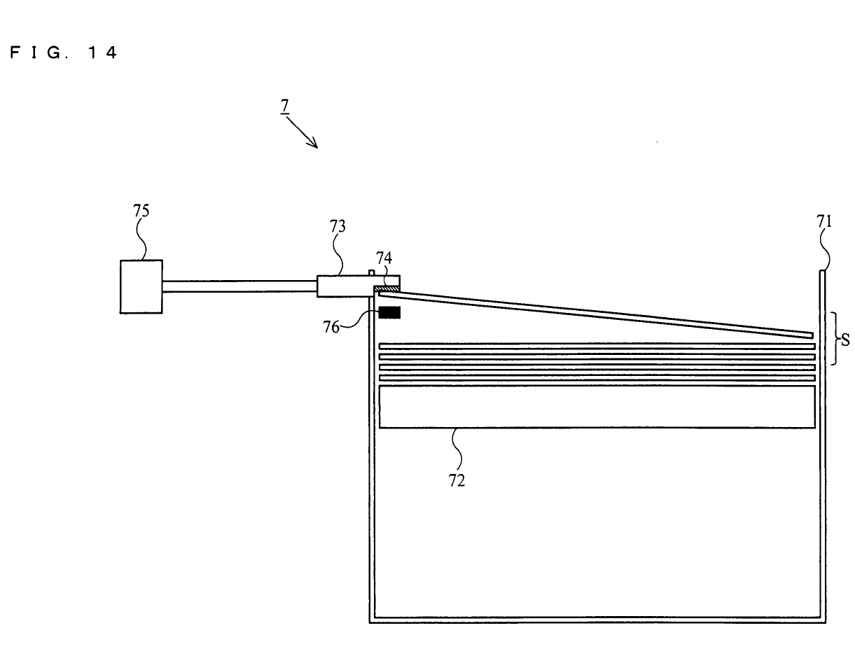

Next, the control section of the board inspecting apparatus 1 drives the actuator 77 so as to protrude the other end of the interposing member 76 into the board case 71 (step S54; the board supplying section 7 as shown in FIG. 14 is in this state) Note that a filled area as shown in FIG. 14 represents the other end of the interposing member 76 protruding into the board case 71. As a result, the other end of the interposing member 76 is inserted into the gap formed by the operation at step S53 between the top board S and the other boards S lying thereunder.

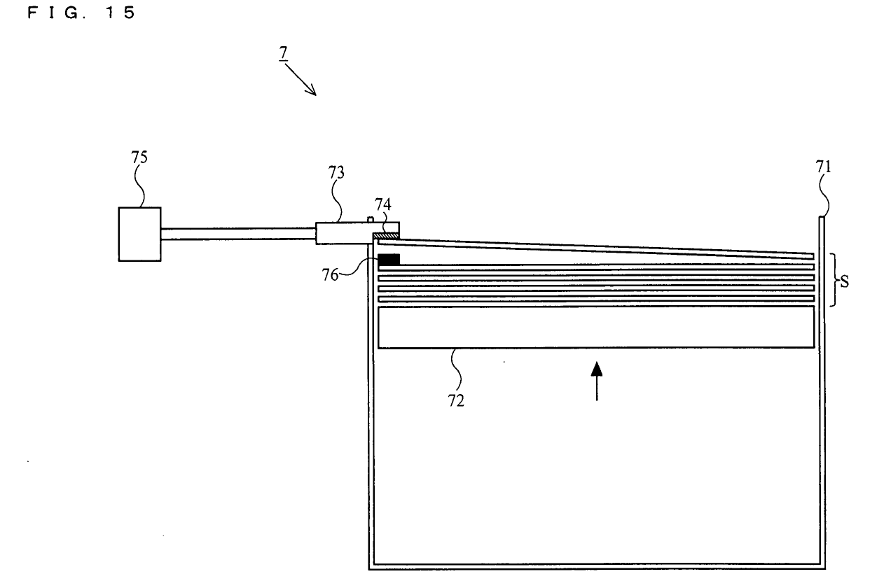

Next, the control section of the board inspecting apparatus 1 moves up the lifting table 72 of the board supplying section 7 (step S55; the board supplying section 7 as shown in FIG. 15 is in this state). The control section moves up the lifting table 72 up to a position in which the second board S loaded in the board case 71 comes in contact with the lower surface of the interposing member 76. As a result, the gap formed by the operation at step S53 between the top board S and the other boards S lying thereunder is narrowed, although the other end of the interposing member 76 has been inserted in the above-described gap.

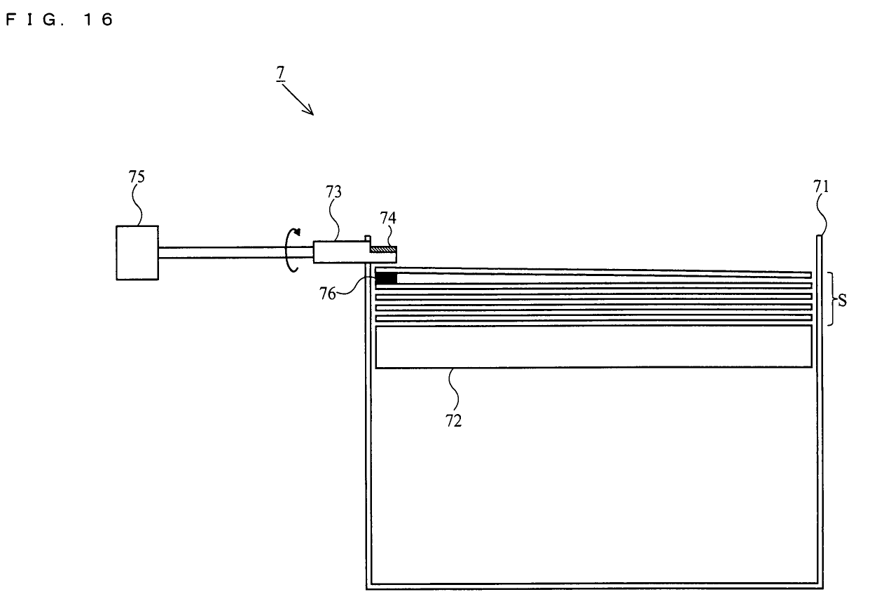

Next, the control section of the board inspecting apparatus 1 drives the actuator 75 to rotate the adhesive member arm 73 by 180 degrees such that the adhesive member 74 faces upward (step S56; the board supplying section 7 as shown in FIG. 16 is in this state). As a result, the adhesive member 74 is located in a position where contact with the top board S is impossible, and the adhesive member 74 and the upper surface of the board S are forcibly separated from each other. That is, the top board S is reliably released from the support of the adhesive member arm 73, and the top board S falls on the second board S. However, the top board S and the second board S do not come in close contact with each other since the other end of the interposing member 76 is inserted therebetween.

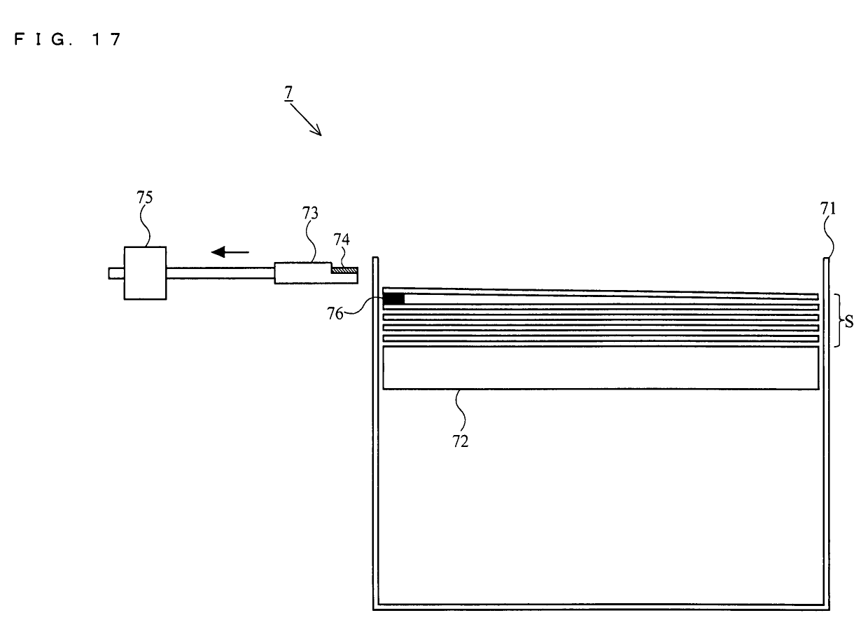

Next, the control section of the board inspecting apparatus 1 drives the actuator 75 so as to retract the adhesive member arm 73 away from the board case 71 (step S57; the board supplying section 7 as shown in FIG. 17 is in this state). As a result, the adhesive member arm 73 is completely withdrawn away from the space above the top board S.

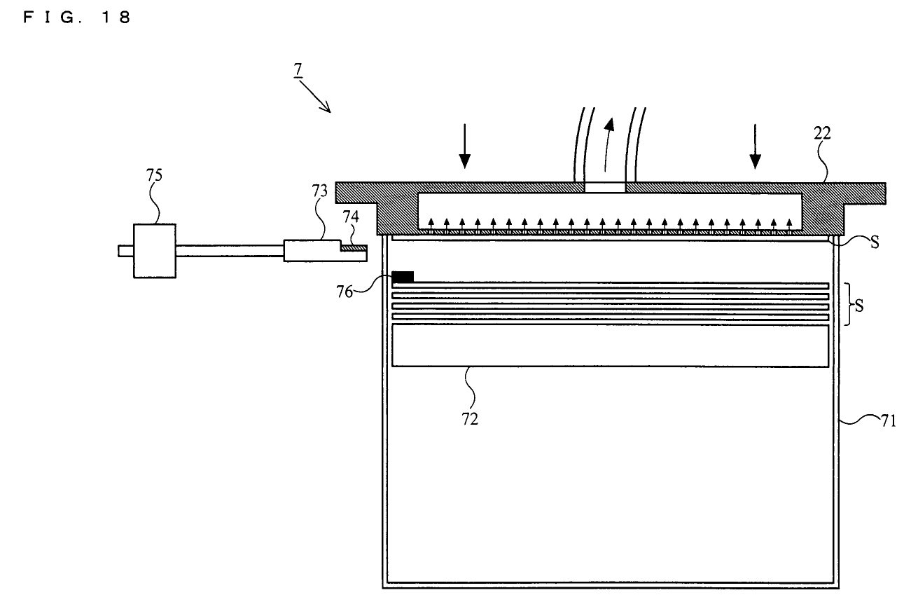

Next, the control section of the board inspecting apparatus 1 extends all the air cylinders 23a to 23d and 33a to 33d (see FIG. 3). Thus, a lower surface of the outer edge of any one of the A-side inspecting suction tables 22a to 22d (an outer surface of the A-side inspecting suction table 22 with respect to the first rotational axis 24) comes in contact with the upper end of the board case 71 of the board supplying section 7, and the suction surface of the A-side inspecting suction table 22 is placed on the opening of the board case 71 (board supplying position). Then, the A-side inspecting suction table 22 located in the board supplying position suctions the top board S, whereby one principal surface of the board S (specifically, the B-side) is vacuum-suctioned to the suction surface of the A-side inspecting suction table 22 (step S58; the board supplying section 7 as shown in FIG. 18 is in this state).

As described in the Related Art Statement section, a plurality of perforations such as through-holes TH and slits SL are formed in the board S. However, since the interposing member 76 is inserted between the top board S and the second board S, the top board S does not come in close contact with the second board S, and the suction force strongly acts on only the top board S. Thus, negative pressure is created in the space between the top board S and the A-side inspecting suction table 22 by the blower suction, and positive pressure (air pressure) is created in the space between the top board S and the second board S. As a result, only the top board S moves upward.

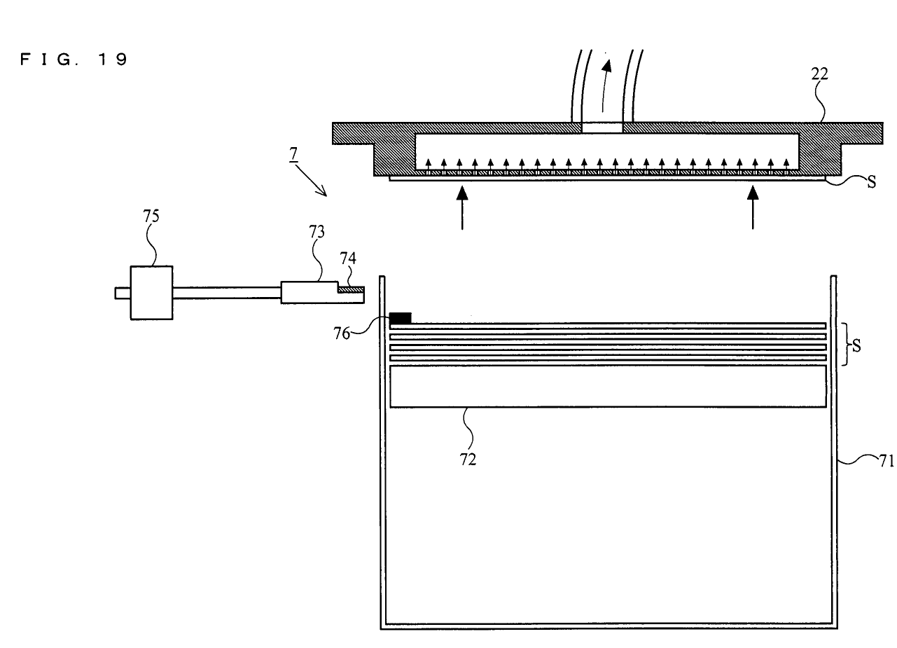

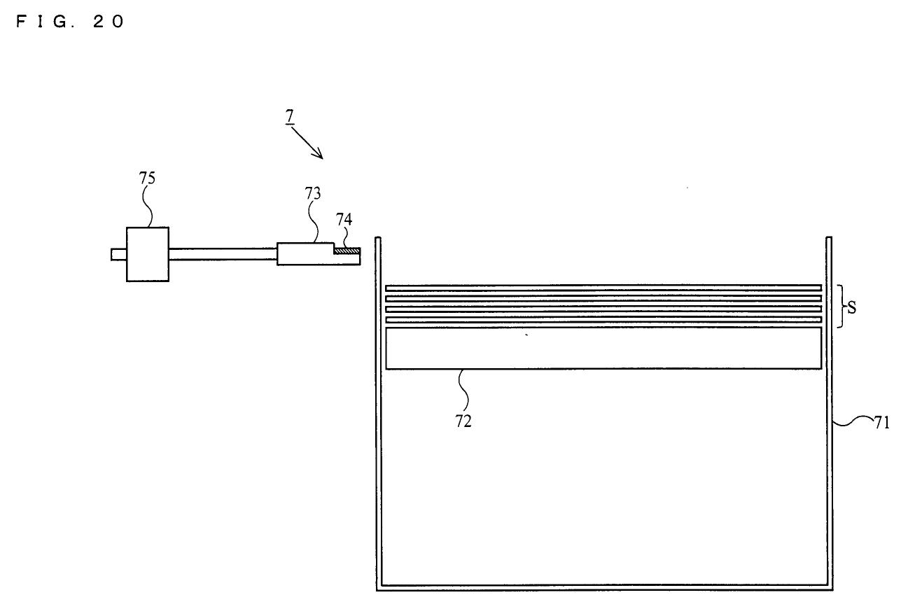

Next, the control section of the board inspecting apparatus 1 retracts all the air cylinders 23a to 23d and 33a to 33d (see FIG. 1). As a result, all the A-side inspecting suction tables 22a to 22d and the B-side inspecting suction tables 32a to 32d are placed in the neighborhood of the sides of the first rotational member 21 and the second rotational member 31, respectively, and the board S which is vacuum-suctioned to the suction surface of the A-side inspecting suction table 22 at step S58 is picked up from the board supplying section 7 (step S59; the board supplying section 7 as shown in FIG. 19 is in this state). Then, the control section drives the actuator 77 such that the other end of the interposing member 76 is retracted away from the board case 71 (step S60; the board supplying section 7 as shown in FIG. 20 is in this state).

Next, the control section of the board inspecting apparatus 1 determines whether or not a supply of the board S is continued (step S61). In the case where it is determined that the supply of the board S is continued, the control section goes back to step S50 and repeats the above-described process. In the case where it is determined that the supply of the board S is terminated, the control section ends the process of the flowchart.

As described above, the board supplying section 7 causes the adhesive member 74 to adhere to the top board S among the loaded boards S. The adhesive member 74 adheres only to the top board S, whereby it is possible to easily separate only the top board S from the other boards S. Also, only the top board S is supported by the adhesive surface of the adhesive member 74 such that a gap is formed between the top board S and the second board S, and the interposing member 76 is inserted into the resulting gap. As a result, a gap is formed between the top board S and the second board S, which are not in close contact with each other, and only the top board S is suctioned by the blower suction. Thus, even if a plurality of perforations are formed in a board, the board picking up apparatus of the present invention can pick up only the top board among a plurality of loaded boards while preventing two or more boards from being picked up at one time. Also, since the board picking up apparatus does not exert intensive stress on the loaded boards, the board can be prevented from being deformed or damaged by selecting an interposing member to be inserted, which is made of a material which does not damage the board. Furthermore, the A-side inspecting suction table 22 vacuum-suctions the whole area of one principal surface of the board S, whereby it is not necessary to adjust a position of a suction pad, etc., according to the shape of the board S.

In the above description, a top board S is temporarily supported by utilizing the adhesive member 74 attached to the adhesive member arm 73, but it is not limited thereto. The top board may be temporarily supported by utilizing other methods. For example, the top board S may be temporarily supported by utilizing electrostatic suction. In this case, control for forcible release of the electrostatic-suctioned top board S can be easily performed by controlling an electrostatic voltage applied for electrostatic suction (e.g., by turning the electrostatic voltage to 0V), whereby the need for a rotational movement at step S56 is eliminated.

In the above description, the lifting table 72 moves up to adhere the top board S to the adhesive member 74. Then, the lifting table 72 moves down so as to widen a gap between the top board S and the second board S. However, other methods may be used as long as a gap between the adhesive member 74 and the top board S adhering thereto and the second board S is relatively reduced or increased. For example, after the adhesive member arm 73 having the adhesive member 74 moves down so as to adhere the top board S to the adhesive member 74, the adhesive member arm 73 may move up in conjunction with the top board S, thereby widening a gap between the top board S and the second board S. In this case, after the interposing member 76 is inserted between the top and second boards S, the adhesive member arm 73 moves down in conjunction with the top board S.

In the above description, the board picking up apparatus of the present invention is applied to a board inspecting apparatus having a plurality of inspecting suction tables, but it is not limited thereto. The board picking up apparatus of the present invention may be applied to other apparatuses. For instance, the board picking up apparatus of the present invention may be applied to a board inspecting apparatus having a single inspecting suction table, a rendering apparatus, or an apparatus for performing other processes. Also, a board to be picked up by the board picking up apparatus may not be a double-sided board requiring visual inspection of both sides thereof.

While the invention has been described in detail, the foregoing description is in all aspects illustrative and not restrictive. It is understood that numerous other modifications and variations can be devised without departing from the scope of the invention.

1. A board picking up apparatus for picking up a board from loaded boards, comprising:
a board case for accommodating the loaded boards;
an adhesive member which adheres to the board accommodated in the board case;
an adhesive member supporting section for supporting the adhesive member;
an adhesive member moving section for moving the adhesive member supporting section between a position in which the adhesive member protrudes into the board case and a position in which the adhesive member retracts away therefrom;
an interposing member;
an interposing member moving section for moving the interposing member between a position in which the interposing member protrudes into the board case and a position in which the interposing member retracts away therefrom; and
a suction table for vacuum-suctioning the board to a suction surface thereof by suctioning the board through an upper portion of the board case,
wherein the adhesive member moving section moves the adhesive member of the adhesive member supporting section so as to protrude into the board case, and causes a loaded top board to adhere to the adhesive member,
wherein the interposing member moving section inserts the interposing member into a gap formed between the board adhering to the adhesive member and other boards by moving the interposing member to protrude into the board case,
wherein the adhesive member moving section releases the top board adhering to the adhesive member from the adhesive member with the interposing member being inserted in the gap, and moves the adhesive member supporting member to the position where the adhesive member is retracted away from the board case, and
wherein the suction table vacuum-suctions the top board with the interposing member being inserted in the gap.

2. The board picking up apparatus according to claim 1,
wherein the gap is formed, after the top board adheres to the adhesive member, by increasing a relative difference in level between the top board adhering to the adhesive member and the other boards.

3. The board picking up apparatus according to claim 1, further comprising:
a lifting table for moving up and down the loaded boards in the board case,
wherein the lifting table causes the loaded top board to adhere to the adhesive member when the adhesive member moving section moves up with the adhesive member of the adhesive member supporting section being protruded into the board case, and
wherein the lifting table forms a gap between the top board and the other boards when the top board adhering to the adhesive member moves downward.

4. The board picking up apparatus according to claim 1,
wherein the adhesive member moving section further rotates the adhesive member supporting section in a predetermined rotational direction,
wherein the adhesive member supporting section supports the adhesive member such that a portion thereof faces downward with respect to the rotational direction, and
the adhesive member moving section releases the top board adhering to the adhesive member from the adhesive member by rotating the adhesive member supporting section in the rotational direction with the interposing member being inserted in the gap.

5. The board picking up apparatus according to claim 1, further comprising:
adhesive power recovery means for cleansing an adhesive surface of the adhesive member by coming in contact with the adhesive surface of the adhesive member, to which a board adheres, at a predetermined time.

6. The board picking up apparatus according to claim 1,
wherein the adhesive member is a tape-shaped member whose one principal surface is adhesive, and
wherein the adhesive member supporting section further includes adhesive member replacing means for replacing a portion of an adhesive surface of the adhesive member, to which a board adheres, with any other portion of the adhesive member at a predetermined time.

7. A board picking up apparatus for picking up a board from loaded boards, comprising:
a board case for accommodating the loaded boards;
an electrostatic suction member which electrostatic-suctions the board accommodated in the board case;
an electrostatic suction member moving section for moving the electrostatic suction member between a position in which the electrostatic suction member protrudes into the board case and a position in which the electrostatic suction member retracts away therefrom;
an interposing member;
an interposing member moving section for moving the interposing member between a position in which the interposing member protrudes into the board case and a position in which the interposing member retracts away therefrom; and
a suction table for vacuum-suctioning the board to a suction surface thereof by suctioning the board through an upper portion of the board case,
wherein the electrostatic suction member moving section moves the electrostatic suction member so as to protrude into the board case, and causes the electrostatic suction member to electrostatic-suction a loaded top board,
wherein the interposing member moving section inserts the interposing member into a gap formed between the board suctioned by the electrostatic suction member and the other boards by moving the interposing member so as to protrude into the board case,
wherein the electrostatic suction member moving section moves the electrostatic suction member so as to retract away from the board case by releasing the top board suctioned by the electrostatic suction member from the electrostatic suction member with the interposing member being inserted in the gap, and
wherein the suction table vacuum-suctions the top board with the interposing member being inserted in the gap.

8. A board picking up method for picking up a board from loaded boards, comprising:
a board adhering step of causing a loaded top board to adhere to an adhesive member by placing the adhesive member over the loaded boards;
an interposing member inserting step of inserting an interposing member into a gap formed between the board adhering to the adhesive member and other boards by moving the interposing member in a space where the boards are loaded;
a board adhesion releasing step of retracting the adhesive member away from a position over the loaded boards by releasing the top board adhering to the adhesive member from the adhesive member with the interposing member being inserted in the gap; and
a vacuum suctioning step of vacuum-suctioning the top board to a suction surface of a suction table by suctioning the board from above with the interposing member being inserted in the gap.

9. The board picking up method according to claim 8, further comprising:
a gap forming step of forming the gap, after causing the top board to adhere to the adhesive member at the board adhering step, by increasing a relative difference in level between the top board adhering to the adhesive member and the other boards.

10. The board picking up method according to claim 9,
wherein the board adhering step causes the loaded top board to adhere to the adhesive member by placing the adhesive member over the loaded boards, and moving up the loaded boards, and
wherein, after the top board adheres to the adhesive member at the board adhering step, the gap forming step forms the gap by moving down the loaded boards.

11. The board picking up method according to claim 8,
wherein the adhesive member is structured such that a portion thereof faces downward with respect to a predetermined rotational direction, and
the board adhesion releasing step releases the top board adhering to the adhesive member from the adhesive member by rotating the adhesive member in the rotational direction with the interposing member being inserted in the gap.

12. The board picking up method according to claim 8, further comprising:
an adhesive power recovering step of cleansing an adhesive surface of the adhesive member by bringing the adhesive surface of the adhesive member, to which a board adheres, into contact with a predetermined member at a predetermined time.

13. The board picking up method according to claim 8,
wherein the adhesive member is a tape-shaped member whose one principal surface is adhesive, and
wherein the method further comprises an adhesive member replacing step of replacing a portion of an adhesive surface of the adhesive member, to which a board adheres, with any other portion of the adhesive member at a predetermined time.

14. A board picking up method for picking up a board from loaded boards, comprising:
a board electrostatic suctioning step of placing an electrostatic suction member over the loaded boards, and causing the electrostatic suction member to electrostatic-suction a loaded top board;
an interposing member inserting step of inserting an interposing member in a gap formed between the board suctioned by the electrostatic suction member and other boards by moving the interposing member in a space where the boards are loaded;
a board electrostatic suction releasing step of retracting the electrostatic suction member away from a position over the loaded boards by releasing the top board suctioned by the electrostatic suction member from the electrostatic suction member with the interposing member being inserted in the gap; and
a vacuum suctioning step of vacuum-suctioning the top board to a suction surface of a suction table by suctioning the board from above with the interposing member being inserted in the gap.
